(19) United States
(12) Patent Application Publication
(10) Pub. No.: US 2014/0090859 A1
(43) Pub. Date: Apr. 3, 2014

(54) FIRE SUPPRESSION SYSTEM FOR BIOMASS STORAGE

(71) Applicant: AIR LIQUIDE INDUSTRIAL U.S. LP, Houston, TX (US)

(72) Inventors: Richard A. SAUER, Hinsdale, IL (US); Richard R. MASI, Newark, DE (US); Adam KEELING, Hoboken, NJ (US)

(73) Assignee: AIR LIQUIDE INDUSTRIAL U.S. LP, Houston, TX (US)

(21) Appl. No.: 13/632,072

(22) Filed: Sep. 30, 2012

(51) Int. Cl. A62C 3/06; A62C 37/00; A62C 35/13; B67C 3/00; E04B 1/35

(52) U.S. Cl. 169/46; 169/68; 169/60; 169/61; 141/1; 52/741.3

(57) ABSTRACT

A biomass fire inside an installation is suppressed with dripping liquid nitrogen from over the biomass and injecting gaseous nitrogen underneath the biomass.

### CROSS-REFERENCE TO RELATED APPLICATIONS

None.

### BACKGROUND

Biomass, sometimes referred to as “hot fuel”, is made up of sawdust, shavings, and yard waste mixed with bark and trimmings from sawmills and other raw wood handling operations. It is used for a variety of purposes, including fuel for stoves or boilers, landfill material, and surfacing playgrounds and paths.

Biomass is stored on a large scale in units typically including a cylindrical base covered with a hemispherical dome. They reach about 150′ high and are about 175′ in diameter. They are fabricated by inflating a balloon-like structure with air and spraying the inner surfaces with Gunnite, a pumpable, high strength concrete product. Once the concrete hardens, the surface is then insulated with a layer of polyurethane. Wall thicknesses of about 12″ are typical near the bottom and about 6″ at the top of the dome.

The biomass is typically conveyed to an interior of the storage unit with a conveyor belt extending to a top of the dome where the solids drop down onto a conical pile inside the unit. In order to reduce dust generation and attrition of the pellets, the fall of the pellets is broken by dropping them into a “ladder” system which results in a reduced impact speed as they are dropped onto the pile. The height of the pile inside the dome will vary, depending on the radial location in the facility and amount of inventory of wood pellets. The pellets are removed from the unit through a grating located at the floor of the unit and onto underground conveyor system. The underground conveyor conveys the pellets to other conveyors which eventually lead to transport ships/vehicles.

While hog fuel generally is fairly moist (in excess of 50% moisture by weight), it is still highly susceptible to spontaneous combustion from biological decomposition. Because of its flammability and combustible energy content, special care should be taken to avoid, detect, and suppress fires in biomass storage units.

In order to reduce the risk that spontaneous combustion will occur, each unit is typically equipped with several air blowers blowing air into the bottom of the unit. The flow of fresh air removes heat from the biomass pile that is produced from biological decomposition. The storage unit also typically includes spark and fire detection units. If a fire does break, the pile may be manually opened up to isolate and thoroughly wet the burning portion to extinguish the fire. International Fire Code 19 calls for automatic fire suppression in the form of water sprinklers and portable fire extinguishers in the unit. Some others recommend the use of dry chemical sprinklers for storage units located in colder climates.

While the above measures have no doubt reduced the overall number of fires and reduced the severity of the fires, they suffer from the drawback that the biomass that is treated with the water or dry chemical is unusable after extinguishing the fire. Because fires are not an uncommon occurrence, this leads to a significant degree of waste.

Thus, there is a need to provide a method and system of fire suppression in biomass storage units that allows for fires to be extinguished without rendering the affected biomass useless for its intended purpose.

### SUMMARY

There is provided a biomass storage installation fire suppression system, comprising: a biomass storage installation comprising a floor, walls extending between a ceiling and said floor, and a grating spaced from, and extending horizontally over, said floor; a liquid nitrogen storage tank; a liquid nitrogen manifold comprising a plurality of liquid nitrogen nozzles and a liquid feed line fluidly communicating between said nozzles and a bottom portion of an interior of said tank, said nozzles being disposed in an upper portion of said installation below the ceiling; and a gaseous nitrogen manifold comprising a gaseous feed line fluidly communicating with a headspace portion of said tank at one end, and at an opposite end, fluidly communicating with an inlet of a blower and/or with a plurality of gaseous nitrogen injectors. In the case of said blower, said blower has an outlet fluidly communicating with a space in between said floor and said grating. In the case of said injectors, said injectors are disposed adjacent and underneath said grating.

There is also provided a method for preparing a biomass storage unit fire suppression system, comprising the steps of providing the above-disclosed biomass storage installation fire suppression system and at least partially filling said tank with liquid nitrogen.

There is also provided a method for installing a biomass storage unit fire suppression system, comprising the following steps. A biomass storage installation is provided that comprises a floor, walls extending between a ceiling and said floor, and a grating spaced from, and extending horizontally over, said floor. A liquid nitrogen storage tank is installed outside said installation. A plurality of liquid nitrogen nozzles are installed in an upper portion of said installation below said ceiling. A liquid feed line is installed between said nozzles and a bottom portion of an interior of said tank. A gaseous feed line is install that fluidly communicates with a headspace portion of said tank. Said gaseous feed line is connected either to a blower or to a plurality of injectors, the blower fluidly communicating with an interior of said housing between said floor and grating, the plurality of injectors being disposed underneath said grating above said floor. The tank is at least partially filled with liquid nitrogen.

There is also provided a method for suppressing fires within a biomass storage installation comprising a floor, walls extending between a ceiling and the floor, and a grating spaced from, and extending horizontally over, the floor, a pile of biomass resting on top of the grating. The improvement comprises dripping liquid nitrogen over the biomass pile and injecting gaseous nitrogen underneath the pile from below the grating.

Any of the above-disclosed systems or methods may include one or more of the following aspects:
a control system is provided that comprises a liquid nitrogen control valve disposed in said liquid manifold, a gaseous nitrogen control valve disposed in said gaseous manifold, and a controller, the controller being programmed, upon receipt of a signal indicating the presence of fire or smoke inside said installation, to open said liquid and gaseous nitrogen control valves allowing a flow of liquid nitrogen from said nozzles and a flow of gaseous nitrogen into said blower or from said injectors.
a plurality of valves each one of which is operatively associated with a corresponding one of said plurality of nozzles.
a plurality of smoke or fire detectors each one of which is coupled with said controller, wherein said controller is programmed to:
   recognize signals from individual ones of said plurality of detectors indicating a potential fire within the installation; and
   open up an individual one or individual ones of said plurality of valves that are disposed nearest to any of said detectors that have sent a signal to the controller indicating a potential fire within the installation.
said controller is programmed to not open individual ones of said plurality of valves that are not disposed nearest to any of said detectors that have sent a signal to the controller indicating a potential fire.
the liquid nitrogen storage tank is disposed outside the installation and is a high pressure cryogenic storage vessel.
the nozzle produces large liquid drops and comprises sintered metal filter element surrounded by a shroud to control separation of any gaseous nitrogen from liquid nitrogen.
a gaseous nitrogen purge line leads from the gaseous feed line to the liquid feed line that includes a valve selectively allowing the liquid feed line and nozzles to be purged.
a blower is included but not injectors for injecting the gaseous nitrogen.
injectors for injecting the gaseous nitrogen are included but not a blower.
at least partially filling said tank with liquid nitrogen.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a schematic of one embodiment of the invention, including injectors.

FIG. 2 is a schematic of another embodiment of the invention including a blower.

FIG. 3 is schematic of yet another embodiment of the invention including both injectors and a blower.

### DETAILED DESCRIPTION

A fire suppression system for biomass storage installations uses liquid nitrogen and gaseous nitrogen to treat both surface fires and fires within the bulk of stored biomass material, respectively. The dual action of liquid nitrogen from above and gaseous nitrogen from below provides several mechanisms for suppressing fire in and/or on the biomass pile.

By injecting the gaseous nitrogen at the base of a pile of biomass allows the gas to rise up and diffuse through the biomass material, thus displacing the oxygen present in the air within the pile (in between the biomass solids) that would otherwise support combustion. Because less oxygen or no oxygen is available to support combustion, the fire is suppressed.

Liquid nitrogen that is dripped onto a surface fire on the biomass pile will be quickly vaporized. The expanded gas acts to displace oxygen present in the air surrounding the surface fire that would otherwise support combustion. Again, because less oxygen or no oxygen is available to support combustion, the fire is suppressed.

The heat of vaporization absorbed by the liquid nitrogen from the biomass solids will also decrease the localized temperature of the biomass solids, thereby reducing the tendency for it to rise above the auto-ignition temperature. Because the biomass solids must be at a temperature above its auto-ignition temperature in order for it to burn, the fire is suppressed by this mechanism as well.

The biomass material also has a tendency to produce volatile off-gases that could be flammable or explosive in the presence of oxygen. Gaseous Nitrogen that is formed as a portion of the liquid Nitrogen is vaporized upon injection from the nozzle will diffuse through the ambient atmosphere inside the biomass storage installation above the biomass pile. When enough gaseous nitrogen accumulates within that atmosphere, the oxygen concentration will drop below the Minimum Oxygen Concentration (MOC) that is necessary for combustion of the off-gases.

The biomass storage installations can be associated with biomass refineries, plants, raw material storage, and/or final product storage. Typically, the biomass includes, but is not limited to, wood pellets, woody plant fibers, grains, saw dust, wood shavings or trimmings, forest or yard waste, grass, wood bark, and the like.

The nitrogen will be stored onsite outside the installation as a liquid in a high pressure cryogenic storage vessel. This pressure of the vessel allows the liquid nitrogen to flow through a section of conventional cryogenic valves and piping to an upper portion of an interior of the installation. The gaseous nitrogen for injecting underneath the biomass pile is provided by passing liquid nitrogen from the vessel through ambient vaporizers.

All types of piping materials can be considered. For gas flow, more commonly, copper, stainless steel and carbon steel are used. For liquid flow, copper or stainless steel are more commonly used. To reduce the effect of the low temperature liquid Nitrogen vaporizing in the piping, insulated pipe should be considered. This could include vacuum jacketed piping or polymer insulated pipe, such as polyurethane foam. A sub-cooler can also be used to increase the cooling capacity and efficiency of the liquid Nitrogen.

Once the liquid piping enters the upper portion of the storage installation, valves, piping and nozzles can be attached at the outlet of the piping to direct the liquid Nitrogen to the location of the surface fire. Any one of a wide variety of known nozzles can be selected to create different types of droplet sizes and spray patterns, anywhere from large liquid drops that freefall quickly in a straight direction to finer droplets that spray outwardly over an angle covering up to 360 degrees. Typically, the liquid drops straight down in order to pinpoint a specific portion of the biomass pile directly under the nozzle. A check valve can also be installed to prevent dust or blockages from occurring in the liquid piping. Typically, the nozzle producing large liquid drops includes a sintered metal filter element surrounded by a shroud to control the separation any gaseous Nitrogen from the liquid nitrogen. The sintered metal filter may be purged periodically to prevent blockages that may accumulate over time. A covered sintered nozzle could be used that extends when liquid or gas flows. This design, with large drops, allows for the longest freefall of liquid Nitrogen and greatest penetration of into the voids inside the pile of solids below. A shrouded nozzle that that does not include a sintered element may also be used. Alternatively, if a finer droplet size is required to provide more inerting power to the headspace above the pile, patterned spray nozzles can be utilized since the finer aerosols would fall more slowly and evaporate more quickly than large droplets.

The amount of nitrogen liquid and gas that is required to suppress fire and eliminate conditions that support combustion can be calculated using models based on process inerting science for solids.

If desired, a near-continuous or continuous supply of gaseous nitrogen may be supplied to the biomass pile underneath it and/or over it. In doing so, the oxygen concentration will be lowered to a level below that what is necessary for supporting combustion. Gaseous nitrogen can be supplied by vaporizing a portion of the liquid nitrogen, or a distillation column-based or gas separation membrane-system may be used instead.

The liquid nitrogen storage vessel will vent gaseous nitrogen if the vessel due to changes in pressure. This is called the Nominal Evaporation Rate (NER). While this gas is ordinarily vented to the atmosphere, it could also be diverted into the liquid nitrogen line and be used to purge the sintered metal filter, if needed, to avoid plugging of the pores with dust.

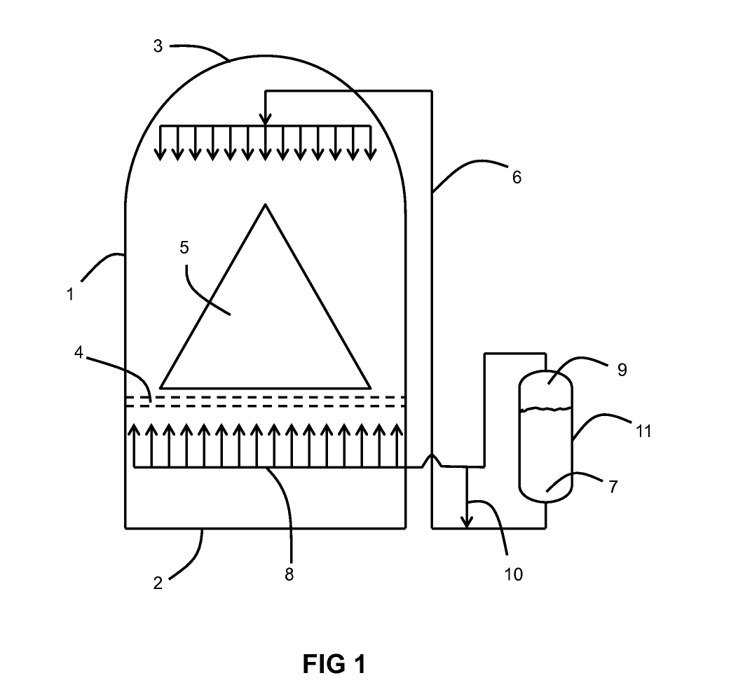

As best illustrated in FIG. 1, one embodiment of the biomass storage installation includes walls 1 that extend between a floor 2 and a ceiling 3.

While the ceiling 3 is shown as dome-shaped, the ceiling can have any configuration suitable for protecting the biomass from the weather. The installation also includes a grating 4 upon which a biomass pile 5 rests. The holes in the grating 4 are sized to allow individual pieces of the biomass from the pile 5 to be withdrawn by a conveyor belt (not shown) in between the grating 4 and floor 2.

A liquid nitrogen manifold 6 includes a liquid nitrogen feed line leading from a lower portion 7 of a high pressure, cryogenic liquid nitrogen storage vessel 11. The liquid drips from a plurality of nozzles at the end of the manifold 6.

A gaseous nitrogen manifold 8 includes a gaseous nitrogen feed line leading from an upper portion 9 of the vessel 11. The gas is injected from a plurality of injectors at the end of the manifold 8. A portion of the gas that would otherwise be vented in order to relieve changes in portion may optionally be diverted via an optional purge line 10 to the liquid feed line in order to purge blockages that may have accumulated on the nozzles from dust within the installation.

In operation, when fire or smoke is detected within the installation, manually or automatically, the flows of gaseous and liquid nitrogen may be initiated either manually or automatically. In the case of automatic initiation of the flows of nitrogen, a control system may be used that includes controller programmed to open valves disposed in the liquid and gaseous feed lines and allow the gaseous and liquid flows of nitrogen.

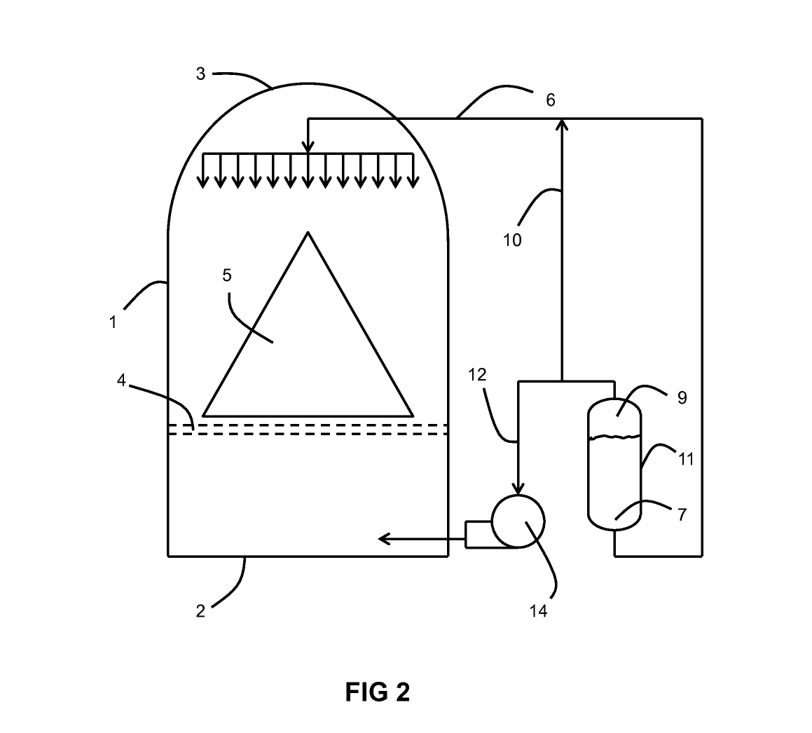

As best shown in FIG. 2, another embodiment of the biomass storage installation similarly includes walls 1 that extend between a floor 2 and a ceiling 3. While the ceiling 3 is shown as dome-shaped, the ceiling can have any configuration suitable for protecting the biomass from the weather. The installation also includes a grating 4 upon which a biomass pile 5 rests. The holes in the grating 4 are sized to allow individual pieces of the biomass from the pile 5 to be withdrawn by a conveyor belt (not shown) in between the grating 4 and floor 2.

A liquid nitrogen manifold 6 includes a liquid nitrogen feed line leading from a lower portion 7 of a high pressure, cryogenic liquid nitrogen storage vessel 11. The liquid drips from a plurality of nozzles at the end of the manifold 6.

While the embodiment of FIG. 2 also includes a gaseous nitrogen feed line 12 leading from an upper portion 9 of the vessel 11, it feeds the gaseous nitrogen to an inlet of a blower 14 instead of injectors (as is the case in the embodiment of FIG. 1). Similar to the embodiment of FIG. 1, a portion of the gas that would otherwise be vented in order to relieve changes in portion may optionally be diverted via an optional purge line 10 to the liquid feed line in order to purge blockages that may have accumulated on the nozzles from dust within the installation.

In operation, when fire or smoke is detected within the installation, manually or automatically, the flows of gaseous and liquid nitrogen may be initiated either manually or automatically. In the case of the gaseous nitrogen flow, the air feed that is ordinarily employed with the blower 14 is manually or automatically shut off and a valve is opened either manually or automatically to instead feed gaseous nitrogen to the inlet of the blower 14. In the case of automatic initiation of the flows of nitrogen, a control system may be used that includes controller programmed to open valves disposed in the liquid and gaseous feed lines and shut off the air feed to the blower 14 to allow the gaseous flows of nitrogen into the installation.

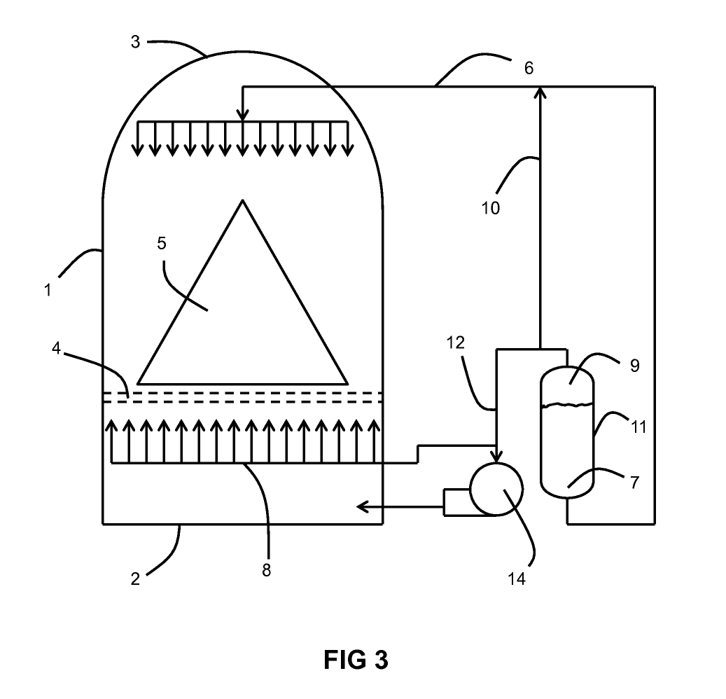

As best illustrated in FIG. 3, yet another embodiment of the biomass storage installation includes walls 1 that extend between a floor 2 and a ceiling 3. While the ceiling 3 is shown as dome-shaped, the ceiling can have any configuration suitable for protecting the biomass from the weather. The installation also includes a grating 4 upon which a biomass pile 5 rests. The holes in the grating 4 are sized to allow individual pieces of the biomass from the pile 5 to be withdrawn by a conveyor belt (not shown) in between the grating 4 and floor 2.

A liquid nitrogen manifold 6 includes a liquid nitrogen feed line leading from a lower portion 7 of a high pressure, cryogenic liquid nitrogen storage vessel 11. The liquid drips from a plurality of nozzles at the end of the manifold 6.

A gaseous nitrogen manifold 8 includes a gaseous nitrogen feed line leading from an upper portion 9 of the vessel 11. Similar to the embodiment of FIG. 1, the gas is injected from a plurality of injectors at the end of the manifold 8. A portion of the gas that would otherwise be vented in order to relieve changes in portion may optionally be diverted via an optional purge line 10 to the liquid feed line in order to purge blockages that may have accumulated on the nozzles from dust within the installation. Similar to the embodiment of FIG. 1, the gaseous nitrogen feed line 12 also feeds the gaseous nitrogen to an inlet of a blower 14

In operation, when fire or smoke is detected within the installation, manually or automatically, the flows of gaseous and liquid nitrogen may be initiated either manually or automatically. In the case of automatic initiation of the flows of nitrogen, a control system may be used that includes controller programmed to open valves disposed in the liquid and gaseous feed lines and allow the gaseous and liquid flows of nitrogen. With respect to the gaseous nitrogen flow in particular, the air feed that is ordinarily employed with the blower 14 is manually or automatically shut off and a valve is opened either manually or automatically to instead feed gaseous nitrogen to the inlet of the blower 14. In the case of automatic initiation of the flows of nitrogen, a control system may be used that includes controller programmed to open valves disposed in the liquid and gaseous feed lines and shut off the air feed to the blower 14 to allow the gaseous flows of nitrogen into the installation.

In any of the embodiments, typically the installation also includes a plurality of smoke or fire detectors, such as thermocouples, suspended from the ceiling 3 spaced at regular intervals.

The controller may programmed to open any and all valves in the liquid feed line so that liquid nitrogen is dripped from each of the nozzles. The controller could also be coupled with each of the thermocouples and also with a plurality of valves each one of which is associated with a nozzle. In this case, the controller may be programmed to recognize signals from individual thermocouples and open up individual valves associated with a nozzle or nozzles disposed adjacent to the thermocouple that is sending a signal to the controller that a fire may be present. This is advantageous in the case that a relatively smaller, isolated fire is present on the surface of the biomass pile. Only the thermocouples that are adjacent to positions overhead the fire will send signals to the controller indicating the possible presence of a fire and liquid nitrogen will be dripped only from those nozzles that are located adjacent to those thermocouples. As a result, only the minimum amount of liquid nitrogen necessary for suppressing the fire is dripped onto the biomass pile.

The dual use of liquid nitrogen and gaseous nitrogen provides many advantages.

Liquid nitrogen has been shown to not damage the biomass particles on contact, unlike other substances, such as water, foam or liquid fire retardant chemicals. Water can cause the biomass to self-heat and burst into flames, making the fire worse. Biomass pellets have been immersed in liquid nitrogen for up to 5 minutes and no degradation has been observed. Because nitrogen is also inert, it contains no substances that would react with the biomass solids and heat them above the auto-ignition temperature.

Liquid nitrogen has also been shown to survive freefall from a significant height, thus keeping its liquid characteristics to suppress the surface fire and allowing greater penetration as it flows through the stored biomass.

Liquid nitrogen is better than inert solids for suppressing surface fires. Inert solids (such as fire retardant solids or solid carbon dioxide) are conventionally used to extinguish surface fires by creating an inert blanket on the surface of the stored biomass. Because they are in solid form, inert solids only minimally penetrate the biomass pile. On the other hand, Liquid nitrogen easily flows through spaces in between the biomass solids in the pile and thus penetrates to a far greater degree. Greater penetration within the pile displaces more oxygen inside the pile and subjects a greater portion of the biomass solids within the pile to the cooling action of liquid Nitrogen.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A biomass storage installation fire suppression system, comprising:
a biomass storage installation comprising a floor, walls extending between a ceiling and said floor, and a grating spaced from, and extending horizontally over, said floor;
a liquid nitrogen storage tank;
a liquid nitrogen manifold comprising a plurality of liquid nitrogen nozzles and a liquid feed line fluidly communicating between said nozzles and a bottom portion of an interior of said tank, said nozzles being disposed in an upper portion of said installation below the ceiling;
a gaseous nitrogen manifold comprising a gaseous feed line fluidly communicating with a headspace portion of said tank at one end, and at an opposite end, fluidly communicating with an inlet of a blower and/or with a plurality of gaseous nitrogen injectors, wherein:
in the case of said blower, said blower has an outlet fluidly communicating with a space in between said floor and said grating; and
in the case of said injectors, said injectors are disposed adjacent and underneath said grating.

2. The biomass storage installation fire suppression system of claim 1, further comprising a control system comprising a liquid nitrogen control valve disposed in said liquid manifold, a gaseous nitrogen control valve disposed in said gaseous manifold, and a controller, the controller being programmed, upon receipt of a signal indicating the presence of fire or smoke inside said installation, to open said liquid and gaseous nitrogen control valves allowing a flow of liquid nitrogen from said nozzles and a flow of gaseous nitrogen into said blower and/or from said injectors.

3. The biomass storage installation fire suppression system of claim 2, further comprising:
a plurality of valves each one of which is operatively associated with a corresponding one of said plurality of nozzles; and
a plurality of smoke or fire detectors each one of which is coupled with said controller, wherein said controller is programmed to:
recognize signals from individual ones of said plurality of detectors indicating a potential fire within the installation; and
open up an individual one or individual ones of said plurality of valves that are disposed nearest to any of said detectors that have sent a signal to the controller indicating a potential fire within the installation.

4. The biomass storage installation fire suppression system of claim 3, wherein said controller is programmed to not open individual ones of said plurality of valves that are not disposed nearest to any of said detectors that have sent a signal to the controller indicating a potential fire.

5. The biomass storage installation fire suppression system of claim 1, wherein the liquid nitrogen storage tank is disposed outside the installation and is a high pressure cryogenic storage vessel.

6. The biomass storage installation fire suppression system of claim 1, wherein the nozzle produces large liquid drops and comprises sintered metal filter element surrounded by a shroud to control separation of any gaseous nitrogen from liquid nitrogen.

7. The biomass storage installation fire suppression system of claim 1, further comprising a gaseous nitrogen purge line leading from the gaseous feed line to the liquid feed line that includes a valve selectively allowing the liquid feed line and nozzles to be purged.

8. The biomass storage installation fire suppression system of claim 1, wherein said system includes a blower but not injectors for injecting the gaseous nitrogen.

9. The biomass storage installation fire suppression system of claim 1, wherein said system includes injectors for injecting the gaseous nitrogen but not a blower.

10. A method for preparing a biomass storage unit fire suppression system, comprising the steps of providing the system of claim 1 and at least partially filling said tank with liquid nitrogen.

11. A method for installing a biomass storage unit fire suppression system, comprising the steps of:
providing a biomass storage installation comprising a floor, walls extending between a ceiling and said floor, and a grating spaced from, and extending horizontally over, said floor;
installing a liquid nitrogen storage tank outside said installation;
installing a plurality of liquid nitrogen nozzles in an upper portion of said installation below said ceiling;
installing a liquid feed line between said nozzles and a bottom portion of an interior of said tank;
installing a gaseous feed line fluidly communicating with a headspace portion of said tank;
connecting said gaseous feed line either to a blower and/or to a plurality of injectors, the blower fluidly communicating with an interior of said housing between said floor and grating, the plurality of injectors being disposed underneath said grating above said floor; and
at least partially filling the tank with liquid nitrogen.

12. The method for installing a biomass storage unit fire suppression system of claim 11, further comprising installing a control system comprising a liquid nitrogen control valve disposed in said liquid manifold, a gaseous nitrogen control valve disposed in said gaseous feed line, and a controller, the controller and control valves being adapted and configured so that electrical signals are received by said control valves from said controller, wherein the controller is programmed, upon receipt of a signal from one or more of said detectors indicating the presence of fire or smoke inside said installation, to open said liquid and gaseous nitrogen control valves allowing a flow of liquid nitrogen from said nozzles and also a flow of gaseous nitrogen from said injectors and/or a flow of gaseous nitrogen to said blower.

13. The method for installing a biomass storage unit fire suppression system of claim 11, further comprising the steps of:
installing a plurality of valves each one of which is operatively associated with a corresponding one of said plurality of nozzles; and
installing a plurality of smoke or fire detectors each one of which is coupled with said controller, wherein said controller is programmed to:
recognize signals from individual ones of said plurality of detectors indicating a potential fire within the installation; and
open up an individual one or individual ones of said plurality of valves that are disposed nearest to any of said detectors that have sent a signal to the controller indicating a potential fire within the installation.

14. The method for installing a biomass storage unit fire suppression system of claim 11, wherein said controller is programmed to not open individual ones of said plurality of valves that are not disposed nearest to any of said detectors that have sent a signal to the controller indicating a potential fire.

15. An method for suppressing fires within a biomass storage installation comprising a floor, walls extending between a ceiling and the floor, and a grating spaced from, and extending horizontally over, the floor, a pile of biomass resting on top of the grating, wherein the improvement comprises:
dripping liquid nitrogen over the biomass pile; and
injecting gaseous nitrogen underneath the pile from below the grating.

16. The method for suppressing fires within a biomass storage installation of claim 15, wherein:
a liquid nitrogen storage vessel is disposed outside the installation;
a liquid nitrogen manifold including a plurality of nozzles and a liquid feed line is in fluid communication between the nozzles and an lower portion of the vessel, a liquid nitrogen control valve being disposed in the liquid feed line;
gaseous nitrogen feed line leads from an upper portion of the vessel, a gaseous nitrogen control valve being disposed in the gaseous feed line;
a plurality of fire or smoke detectors are suspended over the pile; and
upon receipt of a signal or signals from one or more of the plurality of detectors, a controller commands the liquid and gaseous control valves to open.

17. The method for suppressing fires within a biomass storage installation of claim 15, wherein:
a liquid nitrogen storage vessel is disposed outside the installation;
a liquid nitrogen manifold including a plurality of nozzles and a liquid feed line is in fluid communication between the nozzles and an lower portion of the vessel;
a plurality of liquid control valves are respectively operatively associated with individual ones of the plurality of nozzles;
gaseous nitrogen feed line leads from an upper portion of the vessel, a gaseous nitrogen control valve being disposed in the gaseous feed line;
a plurality of fire or smoke detectors are suspended over the pile;
upon receipt of a signal or signals from one or more of the plurality of detectors indicating a potential fire within the installation, a controller is programmed to:
commands the gaseous control valves to open; and
recognize signals from individual ones of the plurality of detectors indicating a potential fire within the installation; and
open up an individual one or individual ones of the plurality of valves that are disposed nearest to any of said detectors that have sent a signal to the controller indicating a potential fire within the installation.

18. The method for suppressing fires within a biomass storage installation of claim 17, wherein said controller is programmed to not open individual ones of said plurality of valves that are not disposed nearest to any of said detectors that have sent a signal to the controller indicating a potential fire.
